(19) United States
(12) Patent Application Publication
(10) Pub. No.: US 2020/0070292 A1
(43) Pub. Date: Mar. 5, 2020

(54) POWER/SIGNAL TRANSMISSION STRUCTURE AND MACHINE TOOL

(71) Applicant: OKUMA Corporation, Niwa-gun (JP)

(72) Inventors: Tomoki HAYASHI, Niwa-gun (JP); Shoichi MORIMURA, Niwa-gun (JP)

(21) Appl. No.: 16/553,589

(22) Filed: Aug. 28, 2019

(30) Foreign Application Priority Data
Aug. 30, 2018 (JP) 2018-161798

(51) Int. Cl. B23Q 3/155; B23Q 3/157; B23Q 5/10

(52) U.S. Cl. CPC B23Q 3/1552; B23Q 5/10; B23Q 3/157

(57) ABSTRACT

A power/signal transmission structure includes: a movable body which has an electrical device, and at least a part of which moves in a processing chamber of a machine tool; a robot provided in the processing chamber; a first connector which relays at least one of power and signals, and which is provided in the movable body 48 and is electrically connected to the electrical device; and a second connector which relays at least one of power and signals, and which is provided in the robot, and is electrically connectable to and disconnectable from the first connector as the robot is driven, wherein at least one of power and signals is transmitted from outside to inside or from inside to outside of the electrical device through the first connector and the second connector.

### CROSS REFERENCE TO RELATED APPLICATION

This application claims priority to Japanese Patent Application No. 2018-161798 filed on Aug. 30, 2018, which is incorporated herein by reference in its entirety including the specification, claims, drawings, and abstract.

### TECHNICAL FIELD

The present specification discloses a transmission structure for transmitting power and/or signals from inside to outside or from outside to inside of a movable body, which is provided in a processing chamber of a machine tool, and at least a part of which is movable, as well as a machine tool capable of incorporating the transmission structure.

### BACKGROUND

Machine tools are required to further improve productivity. Therefore, there is a demand to further add an actuator to a machine tool, to thereby increase the types of processing and work that can be performed by one machine tool. In addition, machine tools are also required to further improve accuracy. Therefore, there is also a demand to newly add a sensor and a cooling mechanism to a machine tool.

The aforementioned actuator, sensor, cooling mechanism, and the like are usually electrical devices driven by electric power. Addition of such an electrical device requires newly installing wiring such as a power line for supplying power to the electrical device and a signal line for transmitting and receiving signals to and from the electrical device. However, such a machine tool may not secure a sufficient space for newly installing wiring, which may make adding an electrical device difficult.

It should be noted that Patent Documents (JP 2016-144853 A, JP 2016-55370 A, and JP 2018-34214 A) disclose that a robot is provided in a machine tool. The Patent Documents describe that tools and workpieces are exchanged using a robot, but do not suggest that a robot is used for transmission of power and signals.

In other words, conventionally, it has been difficult to add an electrical device to a machine tool, which reduced the versatility and scalability of the machine tool. In view of this, the present specification discloses a power/signal transmission structure and a machine tool capable of further improving the versatility and scalability of a machine tool.

### SUMMARY

A power/signal transmission structure disclosed in the present specification comprises: a movable body which has an electrical device, and at least a part of which moves in a processing chamber of a machine tool; a robot provided in the processing chamber; a first connector which relays at least one of power and signals, and which is provided in the movable body or a holding device holding the movable body and is electrically connected to the electrical device; and a second connector which relays at least one of power and signals, and which is provided in the robot and is electrically connectable to and disconnectable from the first connector as the robot is driven, wherein at least one of power and signals is transmitted from outside to inside or from inside to outside of the electrical device through the first connector and the second connector.

In this case, the first connector and the second connector may relay at least the power, and the electrical device may be a device driven by the power and may include at least one of a rotary motor, a linear motor, a solenoid, a solenoid valve, a secondary battery, an electric cylinder, a Peltier element, and a piezoelectric element.

Further, the first connector and the second connector may relay at least the signals, and the electrical device may be a device that transmits and/or receives the signals, and may include at least one of a sensor and a microcomputer.

Further, the movable body may be any one of a tool post, a turret, an opposite head stock, a tailstock, a telescopic cover, a table, a spindle head, a tool holder, a tool, and a steady rest.

Further, the movable body may be installed in the machine tool so as to be inseparable therefrom, and the first connector may be provided in the movable body.

Further, the movable body may be separable from the machine tool, the holding device may be installed in the machine tool so as to be inseparable therefrom, and the first connector may be provided in the holding device. In this case, an intermediate connector for relaying an electrical connection between the electrical device and the first connector may be provided between the movable body and the holding device.

Further, the robot may be able to follow movement of the movable body. In this case, the robot may be installed in the movable body or a holding device holding the movable body.

A machine tool disclosed in the present specification comprises: a holding device provided in a processing chamber for holding a movable body having an electrical device; a robot provided in the processing chamber; a first connector which relays at least one of power and signals, and which is provided in the holding device and is electrically connectable to the electrical device when the movable body is held by the holding device; and a second connector which relays at least one of power and signals, and which is provided in the robot and is electrically connectable to and disconnectable from the first connector as the robot is driven.

According to the power/signal transmission structure and the machine tool disclosed in the present specification, at least one of power and signals can be transmitted from inside to outside or from outside to inside of the electrical device by connecting the second connector to the first connector. As a result, there is no need to separately provide an always-on wire, and thus an electrical device can be easily added. Thus, this structure can further improve the versatility and scalability of the machine tool.

### BRIEF DESCRIPTION OF DRAWINGS

Embodiments of the present disclosure will be described based on the following figures, wherein:

FIG. 1 is a schematic configuration view of a machine tool having a power/signal transmission structure incorporated therein;

FIG. 2 is an enlarged view of the essential parts of the machine tool;

FIG. 3 is a block diagram illustrating an electrical configuration of the machine tool;

FIG. 4 is a block diagram illustrating another example of the electrical configuration of the machine tool;

FIG. 5 is a view illustrating an example in which a solenoid actuator which is an electrical device provided in a tool holder which is a movable body;

FIG. 6 is a view illustrating an example in which a Peltier element which is an electrical device is provided in the tool holder which is a movable body;

FIG. 7 is a view illustrating yet another example of the electrical configuration of the machine tool;

FIG. 8 is a view illustrating still another example of the electrical configuration of the machine tool;

FIG. 9 is a view illustrating further another example of the electrical configuration of the machine tool;

FIG. 10 is a view illustrating still further another example of the electrical configuration of the machine tool; and

FIG. 11 is a view illustrating an example installation of an in-machine robot.

### DESCRIPTION OF EMBODIMENTS

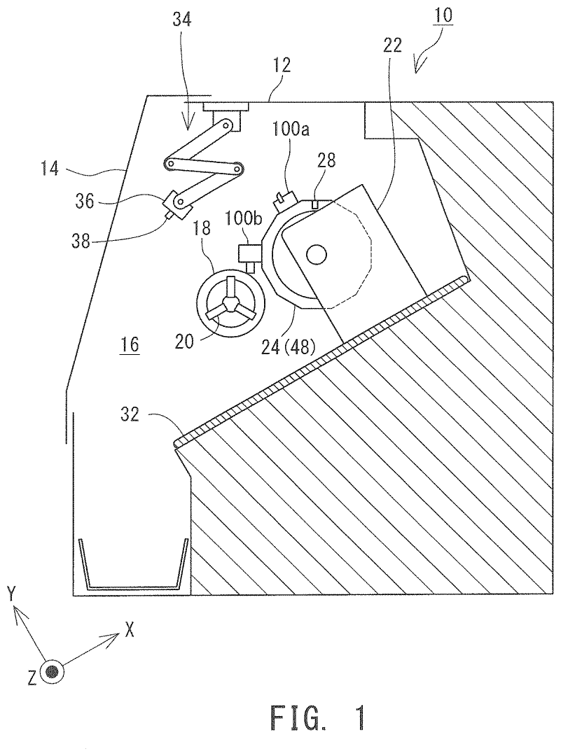

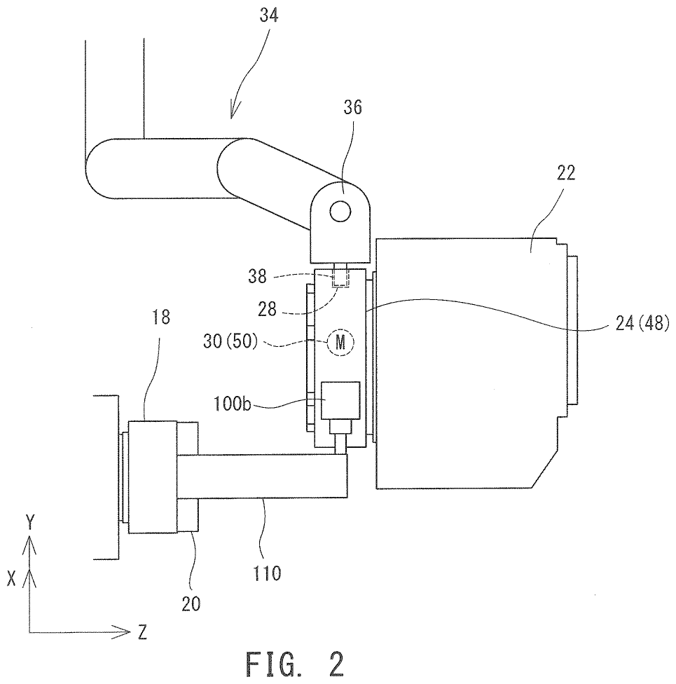

Hereinafter, the configuration of a power/signal transmission structure and a machine tool 10 will be described with reference to the accompanying drawings. FIG. 1 is a schematic configuration view of the machine tool 10 having the power/signal transmission structure incorporated therein. FIG. 2 is an enlarged view of the essential parts of the machine tool 10. Note that in the following description, a Z-axis indicates a direction parallel to a rotating shaft of a work spindle 18, an X-axis indicates a direction parallel to a movement direction orthogonal to the Z-axis of a tool post 22, and a Y-axis indicates a direction orthogonal to the X-axis and the Z-axis. Further, on the Z-axis, a positive direction is defined as a direction oriented from the work spindle 18 to the tool post 22; on the X-axis, the positive direction is defined as a direction oriented from the work spindle 18 to the tool post 22; and on the Y-axis, the positive direction is defined as a direction oriented from the work spindle 18 to the upward direction

This machine tool 10 is a lathe that processes a workpiece 110 by pressing a lathe cutting tool 100a held by the tool post 22 against the rotating workpiece 110 (unillustrated in FIG. 1). Note that in the following description, the lathe cutting tool 100a and a rotating tool 100b are simply referred to as a “tool 100” unless particularly distinguished.

More specifically, this machine tool 10 is a turret lathe comprising a turret 24 which is NC controlled and which holds a plurality of tools 100. A periphery of a processing chamber 16 of the machine tool 10 is covered with a cover 12. A front surface of the processing chamber 16 includes a large opening, which is opened and closed by a door 14. The operator accesses each portion inside the processing chamber 16 through this opening. During processing, the door 14 is closed. This is to ensure safety, environmental performance, and the like.

The machine tool 10 includes a work spindle device rotatably holding one end of the workpiece 110; the tool post 22 holding the tool 100; a tailstock (unillustrated) supporting the other end of the workpiece 110; and a telescopic cover 32 covering a bottom surface of the processing chamber 16, all of which are installed in the machine tool 10 so as to be inseparable therefrom. The work spindle device includes a head stock (unillustrated) incorporating a drive motor and the like, and a work spindle 18 attached to the head stock. The work spindle 18 includes a chuck 20 or a collet holding the workpiece 110 in an attachable and detachable manner, and the workpiece 110 held can be replaced as needed. Further, the work spindle 18 and the chuck 20 rotate about a work rotating shaft extending in a horizontal direction (the Z-axis direction in FIG. 1).

The tailstock is disposed opposite the work spindle 18 in the Z-axis direction, and supports the other end of the workpiece 110 held by the work spindle 18. The tailstock is movable in the Z-axis direction to be attached to and detached from the workpiece 110. Note that instead of or in addition to the tailstock, an opposite spindle for rotatably holding another workpiece may be provided.

The tool post 22 holds the tool 100; for example, a lathe cutting tool 100a called a single point cutting tool. The entire tool post 22 is movable in the Z-axis; that is, in a direction parallel to the axis of the workpiece 110. Further, the entire tool post 22 can also advance and retract in a direction parallel to the X-axis; that is, in a radial direction of the workpiece 110. Note that as is apparent from FIG. 1, the X-axis is inclined with respect to the horizontal direction so as to move upward while advancing to a rear side as viewed from the opening of the processing chamber 16.

The turret 24 capable of holding a plurality of tools 100 is provided at a distal end of the tool post 22. The turret 24 has a polygonal shape as viewed in the Z-axis direction and can rotate about an axis parallel to the Z-axis. A plurality of inlay holes for attaching a tool holder are formed on a peripheral surface of the turret 24. A part of the tool holder is inserted into this inlay hole and then is fastened to the turret 24 by a bolt. The tool 100 is mounted on the turret 24 with this tool holder interposed therebetween. Note that in the present example, the turret 24 further includes a first connector 28 and a rotary motor 30 electrically connected to the first connector 28, which will be described later.

In any case, the tool 100 for use in processing the workpiece 110 can be changed as needed by rotating the turret 24. Further, the tool 100 held by this turret 24 moves in a direction parallel to the Z-axis by moving the tool post 22 in the direction parallel to the Z-axis. Furthermore, the tool 100 held by the turret 24 moves in a direction parallel to the X-axis by moving the tool post 22 in the direction parallel to the X-axis. Still furthermore, cut depth and the like of the workpiece 110 by the tool 100 can be changed by moving the tool post 22 in the direction parallel to the X-axis. In other words, the tool 100 attached to the tool post 22 is movable in a plane parallel to an XZ plane.

The telescopic cover 32 is provided on the bottom surface of the processing chamber 16. The telescopic cover 32 is installed so as to cover a sliding member (such as a guide rail) of the tool post 22 and the tailstock. The telescopic cover 32 prevents swarf from entering the sliding member while allowing movement of the tool post 22 and the like. This telescopic cover 32 has a plurality of partially overlapping cover 12 pieces and can be expanded or contracted by moving each cover 12 piece in a surface direction so as to change the amount of overlapping cover 12 pieces.

Further, an in-machine robot 34 is provided in the processing chamber 16 so as to be inseparable from the machine tool 10. In the present example, the in-machine robot 34 is an articulated robot having a plurality of arms. In the present example, the in-machine robot 34 is installed on a top surface of the processing chamber 16, but the installation location and configuration of the in-machine robot 34 may be changed as needed so long as a second connector 38 to be described later can be connected to the first connector 28. For example, the in-machine robot 34 may be attached to a wall surface of the processing chamber 16, or the tool post 22, the work spindle 18, the tailstock, or the like.

The in-machine robot 34 has a plurality of arms connected through joints. An end effector 36 is provided at a distal end of the in-machine robot 34. This end effector 36 includes a second connector 38 for relaying at least one of power and signals, which will be described later. In any case, movement of an arm of the in-machine robot 34 causes the position and orientation of the end effector 36 and eventually the second connector 38 to be changed. Note that in the illustrated example, only one second connector 38 is provided at an end of the in-machine robot 34, but the number of the second connectors 38 and the installation position thereof may be changed as needed so long as the second connector 38 is provided in the in-machine robot 34.

Meanwhile, as is clear from the above description, the machine tool 10 of the present example is a lathe which processes the workpiece 110 by pressing the tool 100 against the workpiece 110 in a state of rotating the workpiece 110. Recent years have seen a demand for even such a lathe to perform processing other than lathe cutting. For example, there is a demand for a turret lathe to cause the rotating tool 100b to perform rotary cutting on the workpiece 110. In light of this, some have proposed a machine tool 10 in which a rotary motor 30 or the like is provided inside the turret 24 so as to cause the turret lathe to perform rotary cutting. Such a machine tool 10 allows the rotating tool 100b to be mounted on the turret 24. Further, the turret 24 includes therein the rotary motor 30 and a transmission mechanism (such as gears, unillustrated) for transmitting the rotational force of the rotary motor 30 to the rotating tool 100b. Such a configuration allows one machine tool 10 to perform both lathe cutting and rotary cutting, and thus can further improve the productivity of the machine tool 10.

However, in order to provide the rotary motor 30 inside the turret 24, wiring is required to supply power to and transmit and receive a signal to and from the rotary motor 30. However, such a new installation of wiring has sometimes been difficult due to space constraints. In particular, an electrical device 50 is provided in a movable body 48, at least a part of which is movable in the processing chamber 16, like the turret 24. The wiring connected to the electrical device 50 provided in such a movable body 48 requires a mechanism for preventing the wiring from being entangled or broken as the movable body 48 moves, which tends to complicate the structure.

In light of this, in the present example, at least one of power and signals is transmitted to the electrical device 50 provided in the movable body 48 through the in-machine robot 34 provided in the processing chamber 16. More specifically, the turret 24 (movable body 48) of the present example incorporates the rotary motor 30 (electrical device 50). This rotary motor 30 is connected to an input terminal of the transmission mechanism incorporated in the turret 24. An output terminal of the transmission mechanism is connected to the rotating tool 100b inserted into a specified inlay hole. When the rotary motor 30 is rotationally driven, the rotating tool 100b rotates and the workpiece 110 can be rotationally cut.

The turret 24 (movable body 48) further includes the first connector 28 for relaying at least one of power and signals. In the present example, the concave first connector 28 is provided on a peripheral surface of the polygonal turret 24. This first connector 28 is electrically connected to the rotary motor 30 (electrical device 50).

As described above, the in-machine robot 34 includes the second connector 38 connectable to this first connector 28. This second connector 38 is electrically connected to an unillustrated power supply 40 or a signal transmission/reception unit or both of them. The in-machine robot 34 can electrically connect the second connector 38 to the first connector 28 by driving a drive unit 39 provided in each joint.

The types of the first connector 28 and the second connector 38 are not particularly limited so long as they can relay power or signals or both of them. Therefore, the first connector 28 and the second connector 38 may be any known type of connector. Examples of the first connector 28 and the second connector 38 include a communication connector (such as a DS connector and a LAN connector), a computer connector (such as a USB connector and a DIN connector), a power supply connector, a coaxial connector (such as an SMP connector and an SMB connector), a circular connector, a square connector, and an optical connector (such as an MT connector and an FC connector). Further, the first connector 28 and the second connector 38 may be a power-dedicated connector and a signal-dedicated connector respectively or may be a connector capable of relaying both power and signals. Furthermore, the first connector 28 and the second connector 38 may be a contact connector or a non-contact connector electrically connected in a non-contact manner.

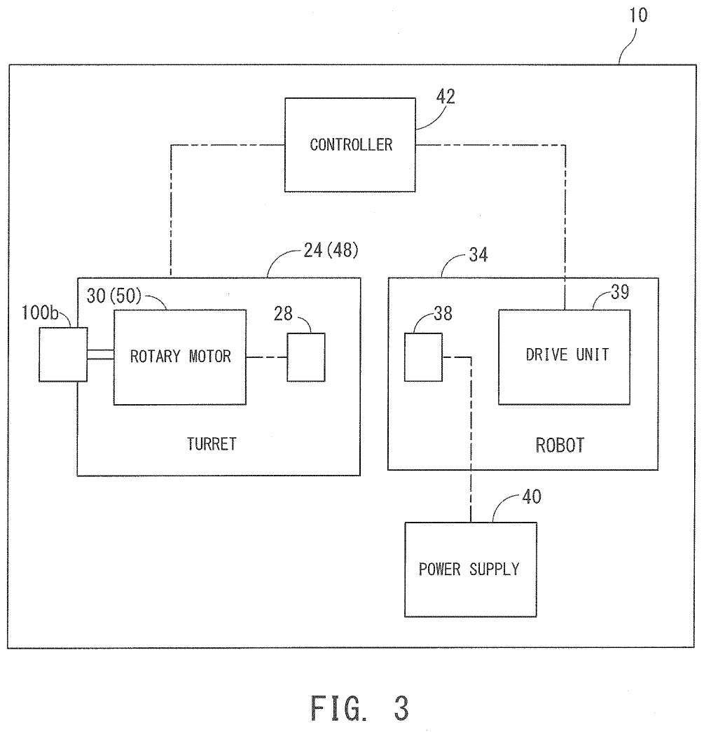

In the present example, the first connector 28 and the second connector 38 are connectors for relaying power, and the second connector 38 is connected to a power supply of the machine tool 10. Such a power/signal transmission structure will be further described with reference to FIG. 3. FIG. 3 is a block diagram illustrating an electrical configuration of the machine tool 10. Note that FIG. 3 illustrates only the components particularly involved in supplying power to the rotary motor 30, and other components are omitted. Note also that in FIG. 3, a one-dot chain line indicates power wiring, and a two-dot-chain line indicates signal wiring.

As described above, the turret 24 is a movable body 48 which can move in the processing chamber 16. This movable body 48 (turret 24) includes therein the rotary motor 30 which is the electrical device 50. The movable body 48 (turret 24) further also includes the first connector 28 which is a power connector. This first connector 28 is connected to the electrical device 50 through a power line.

The in-machine robot 34 includes the drive unit 39 for moving each arm and the second connector 38. The drive unit 39 is for moving each arm, and includes a drive motor and a rotational position sensor (such as an encoder) provided at each joint. The second connector 38 is a power connector which can be connected to the first connector 28. This second connector 38 is connected to the power supply 40 provided outside or inside the in-machine robot 34 through the power line.

Note that a controller 42 of the machine tool 10 controls driving of the movable body 48 itself and driving of the drive unit 39. The controller 42 is a computer; for example, a numerical control device, which includes one or more CPUs and a storage unit for storing various data and programs. Note also that the movable body 48 and the drive unit 39 are also connected to the power supply 40 and are driven by the power supplied from the power supply 40.

For rotary cutting, the controller 42 drives the drive unit 39 of the in-machine robot 34 to change the position and the orientation of the in-machine robot 34 so that the second connector 38 can be connected to the first connector 28. When the second connector 38 is connected to the first connector 28, power is supplied to the rotary motor 30 inside the turret 24 to drive the rotary motor 30. This is ready for rotary cutting.

As described above, according to the present example, power is supplied to the rotary motor 30 through the in-machine robot 34. This case eliminates the need to install wiring in the turret 24 from the rotary motor 30 toward the power supply 40, which can simplify the structure inside the turret 24. Further, when the rotary motor 30 is not used, the in-machine robot 34 can be retracted to an unobtrusive position. Even if the turret 24 or the tool post 22 moves in this state, the wiring will not be entangled or broken.

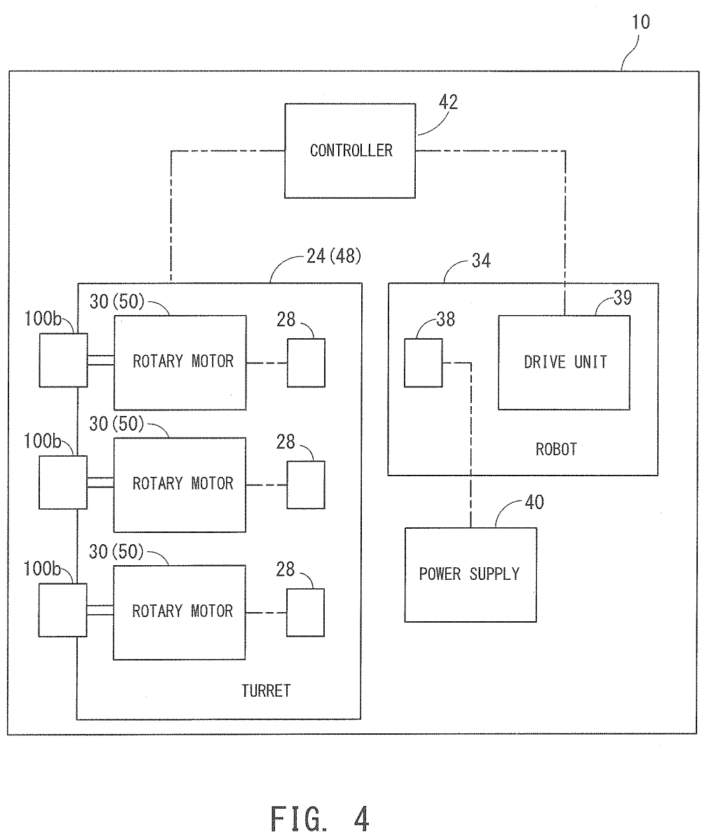

Note that hereinbefore, the description has been made of only the case in which one rotary motor 30 is provided in one turret 24, but as illustrated in FIG. 4, a plurality of rotary motors 30 may be provided in one turret 24. In this case, a first connector 28 is also provided for each rotary motor 30. The controller 42 specifies a rotary motor 30 connected to the rotating tool 100b to be used, and connects the second connector 38 to a first connector 28 corresponding to the specified rotary motor 30, to thereby enable use of the desired rotating tool 100b.

Such a configuration can set a plurality of rotating tools 100b to one turret 24 without complicating the wiring. As a result, this configuration can continuously perform processing by a plurality of types of rotating tools 100b without tool replacement in the middle, which can further improve the productivity of the machine tool 10.

Note that hereinbefore, the description has been made of the case in which the rotary motor 30 which is a type of the electrical device 50 is provided in the turret 24 which is a type of the movable body 48. However, the electrical device 50 electrically connected to the first connector 28 is not limited to the rotary motor 30, but may be any other electrical device 50. Note also that the movable body 48 in which the electrical device 50 is provided may be any body other than the turret 24 so long as at least a part of the body is movable in the processing chamber 16.

For example, the electrical device 50 may be a chargeable and dischargeable battery. Specifically, a battery and the first connector 28 electrically connected to the battery may be provided in the movable body 48 such as the turret 24, the tool post 22, an opposite spindle, and a spindle head. In this case, another electrical device 50 driven by the power supplied from the battery is provided in the movable body 48 or any other member mechanically connected to the movable body 48. Further, the second connector 38 connected to the power supply 40 is provided in the in-machine robot 34, and the second connector 38 is connected to the first connector 28, to thereby enable charging of the battery. For example, a chargeable and dischargeable battery and the rotary motor 30 driven by the power supplied from the battery may be provided in the turret 24. When the charge capacity of the battery decreases, the second connector 38 provided in the in-machine robot 34 may be connected to the first connector 28 to charge the battery.

Further, the electrical device 50 may be a solenoid valve provided in the middle of a fluid path. Specifically, the fluid path in which liquid or gas flows and one or more solenoid valves provided in the middle of the fluid path are provided inside the movable body 48 such as an opposite spindle, the turret 24, the tool post 22, and the telescopic cover 32. Further, the movable body 48 also includes the first connector 28 electrically connected thereto through each solenoid valve and the power line. The in-machine robot 34 includes the second connector 38 connected to this power supply 40. When the second connector 38 is connected to the first connector 28, power is supplied to the solenoid valve. Then, the valve is opened and fluid is ejected. The fluid ejected in this manner can be used to cool the workpiece 110 and the tool 100 or to clean the swarf dropped on the bottom surface of the processing chamber 16. Note that this technique may be applied not only to the lathe but also to a machining center and a multi-tasking machine. Therefore, the above described solenoid valve, fluid path, and first connector may be provided in the spindle head provided in the machining center or the multi-tasking machine and a table on which the workpiece is placed.

Further, another form of the electrical device 50 may be a sensor. The sensor may be a vibration sensor, a temperature sensor, a non-contact distance-measuring sensor (such as a laser sensor), an image sensor (such as a CCD), and the like. Further, the movable body 48 in which this sensor is provided may be the turret 24, the tool post 22, an opposite head stock, and a tailstock provided in the lathe, or a spindle head and a table provided in the machining center, and the like. The first connector 28 is provided in the movable body 48 and is connected to the sensor through the signal line. The in-machine robot 34 includes the second connector 38 connected to the controller 42 of the machine tool 10 or to another computer through the signal line. When this second connector 38 is connected to the first connector 28, a signal detected by the sensor is transmitted to the controller 42 or to the other computer. Therefore, for example, the vibration sensor and the first connector 28 may be provided in the tool post 22, and the second connector 38 connected to the controller 42 of the machine tool 10 may be provided in the in-machine robot 34. In this case, during processing, the second connector 38 is connected to the first connector 28 to transmit to the controller 42 a signal indicating the vibration detected by the vibration sensor. Then, based on the obtained signal, the controller 42 determines whether or not the processing state is appropriate and adjusts a control parameter related to the processing, which can further improve the processing accuracy.

Further, still another form of the electrical device 50 may be a microcomputer (such as an integrated circuit). This microcomputer is provided in the movable body 48; for example, the turret 24, the tool post 22, the opposite head stock, the tailstock, the spindle head, the table, and the like. Further, the movable body 48 includes the first connector 28 connected to the microcomputer through the signal line. The in-machine robot 34 includes the second connector 38 connected to the controller 42 of the machine tool 10 or to another computer through the signal line. When this second connector 38 is connected to the first connector 28, signals can be transmitted and received between the computer inside the movable body 48 and the controller 42 or the other computer. Note that the microcomputer inside the movable body 48 may control driving of various actuators (such as a rotary motor 30) provided in the movable body 48 or may collect and analyze the signals detected by various sensors provided in the movable body 48.

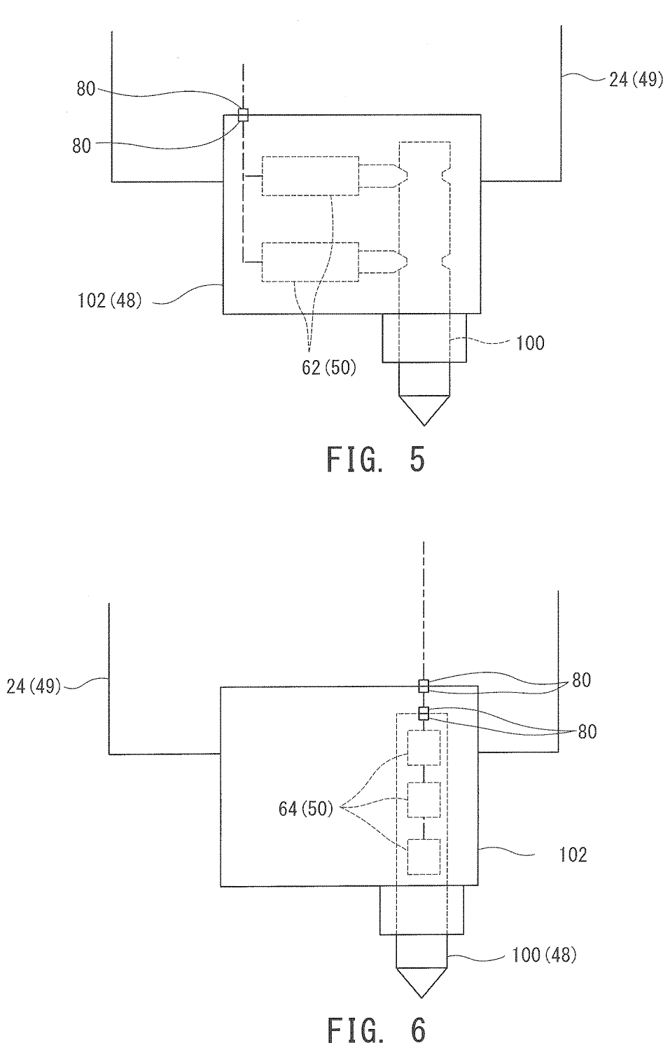

Note that hereinbefore, the description has been made of the example in which a body provided in the machine tool 10 so as to be inseparable therefrom is assumed to be the movable body 48 and both the electrical device 50 and the first connector 28 are provided in this movable body 48. However, the movable body 48 may be separable from the machine tool 10 and the first connector 28 may be provided in the holding device holding the movable body 48. Therefore, for example, as illustrated in FIG. 5, a solenoid actuator 62 which is the electrical device 50 may be provided in a tool holder 102 attachable to and detachable from the turret 24 and the first connector 28 (unillustrated in FIG. 5) electrically connected to the solenoid actuator 62 may be provided in the turret 24.

In this case, this tool holder 102 is inserted into and held by an inlay hole of the turret 24. The solenoid actuator 62 has a piston that can advance and retract in the radial direction of the tool 100. This piston is urged in the advancing direction by an elastic material such as a spring. When the solenoid is de-energized, the piston advances to the side of the tool 100 and is engaged with a part of the tool 100, thereby to prevent attachment and detachment of the tool 100. On the other hand, when the solenoid is energized, the piston retracts in a direction away from the tool 100 by electromagnetic force, and thus the tool 100 can be attached or detached. In other words, the solenoid actuator 62 functions as a tool lock mechanism for controlling the attachment and detachment of the tool 100 from the tool holder 102.

In this case, the turret 24 functions as a holding device 49 holding the tool holder 102 which is the movable body 48. This turret 24 includes the first connector 28 electrically connected to this solenoid actuator 62. From another point of view, in the present example, a power line connecting the first connector 28 and the solenoid actuator 62 crosses the turret 24 and the tool holder 102. As used herein, the tool holder 102 is usually attachable to and detachable from the turret 24. Therefore, desirably an opposing surface of the turret 24 and the tool holder 102 includes another connector (intermediate connector 80) for relaying the power line in the tool holder 102 and the power line inside the turret 24.

The in-machine robot 34 includes the second connector 38 that is electrically connectable to this first connector 28. This second connector 38 is connected to the power supply 40. Thus, when the second connector 38 is connected to the first connector 28 by driving the in-machine robot 34, the solenoid actuator 62 is energized and the tool 100 is unlocked. As a result, the tool 100 is attachable and detachable.

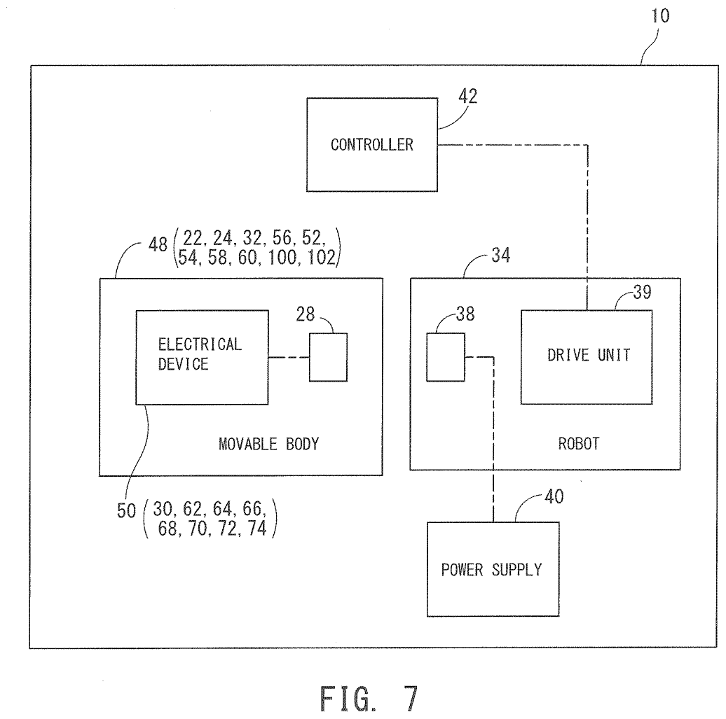

Further, still another form of the movable body 48 in which the electrical device 50 is provided may be the tool 100 held by the turret 24 with the tool holder 102 interposed therebetween. FIG. 6 is a view illustrating an example of this case. In the example of FIG. 6, a Peltier element 64 which is the electrical device 50 is provided on a surface of the tool 100 functioning as the movable body 48. The turret 24 functions as the holding device 49 holding the tool 100 with the tool holder 102 interposed therebetween. This turret 24 includes the first connector 28, and the Peltier element 64 is connected to the first connector 28 through the power line. Note that each of the opposing surface between the tool 100 and the tool holder 102 and the opposing surface between the tool holder 102 and the turret 24 includes the intermediate connector 80 which allows connection and disconnection of the power line.

The second connector 38 provided in the in-machine robot 34 is connected to the power supply. When this second connector 38 is connected to the first connector 28, power flows through the Peltier element 64 to enable cooling by the Peltier effect. This can suppress an increase in temperature of the tool 100 and can improve the lifetime and accuracy of the tool 100.

Further, in still another form, various sensors (electrical device 50) may be provided in the tool 100 or the tool holder 102 (movable body 48), and the first connector 28 may be provided in the turret 24 holding the tool 100 or the tool holder 102, or the tool post 22 or the spindle head (holding device).

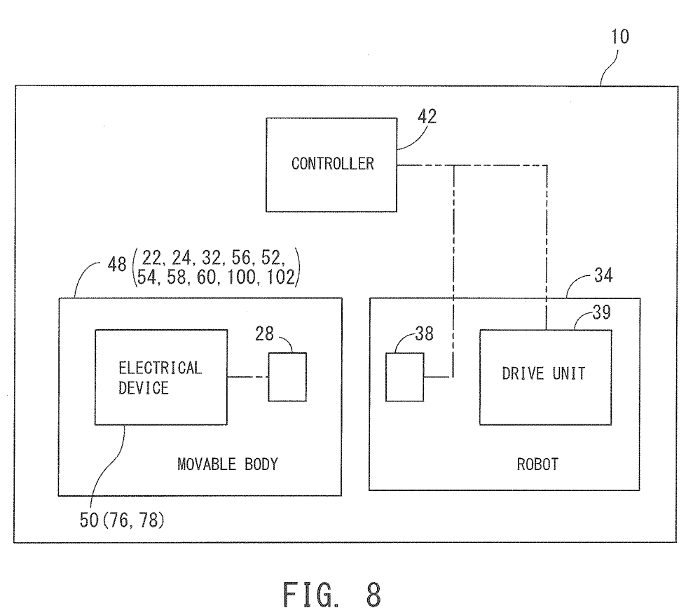

Then, the description will focus on the electrical configuration described so far with reference to FIG. 7 to FIG. 10. FIG. 7 to FIG. 10 illustrate the electrical configuration of the signal transmission structure. In each Figure, a one-dot chain line indicates power wiring, and a two-dot-chain line indicates signal wiring. As described above, and as illustrated in FIG. 7, the electrical device 50 and the first connector 28 may be provided in the movable body 48. Further, the first connector 28 and the second connector 38 may be a connector for relaying power. In this case, the movable body 48 may be a body provided in the machine tool 10 so as to be inseparable therefrom; for example, the turret 24, the tool post 22, the tailstock 56, the telescopic cover 32, the opposite spindle 54, the spindle head 52, a table 58, and the like. In this case, the electrical device 50 may be the rotary motor 30, a linear motor 66, the solenoid actuator 62, a solenoid valve 68, a battery 70, an electric cylinder 72, and the like. Further, still another form of the movable body 48 may be a body provided in the machine tool 10 in an attachable and detachable manner; for example, the tool holder 102, the tool 100, the steady rest 60, and the like. In this case, the electrical device 50 may be the solenoid actuator 62, the electric cylinder 72, a piezoelectric element 74, the Peltier element 64, and the like.

Further, as illustrated in FIG. 8, the first connector 28 and the second connector 38 may be a connector relaying signal. In this case, the movable body 48 may be a body provided in the machine tool 10 so as to be inseparable therefrom; for example, the turret 24, the tool post 22, the tailstock 56, the telescopic cover 32, the opposite spindle 54, the spindle head 52, the table 58, and the like. Furthermore, the movable body 48 may be a body provided in the machine tool 10 so as to be inseparable therefrom; for example, the tool holder 102, the tool 100, the steady rest 60, and the like. In any case, in this case, the electrical device 50 is a device that outputs signals to outside or receives signals from outside, and the examples thereof include the sensor 76 and the microcomputer 78.

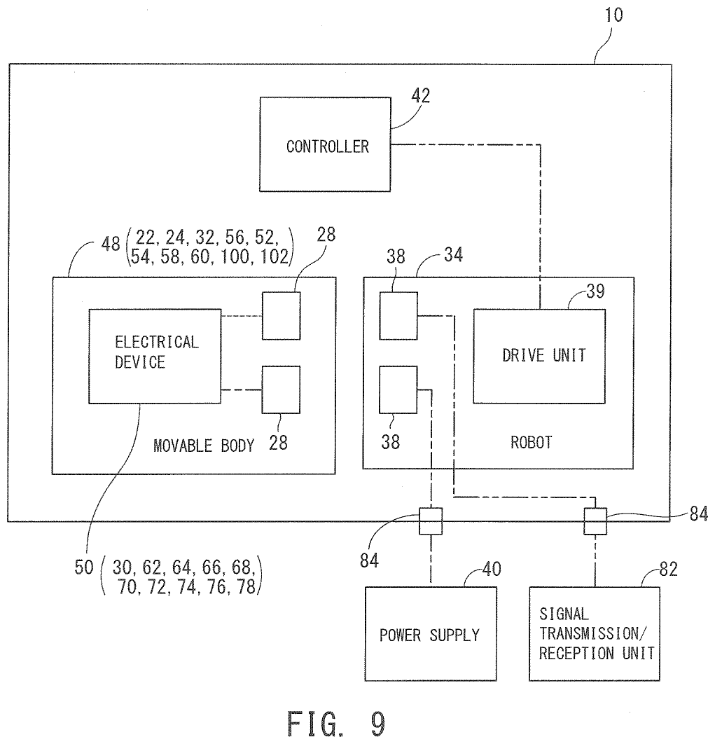

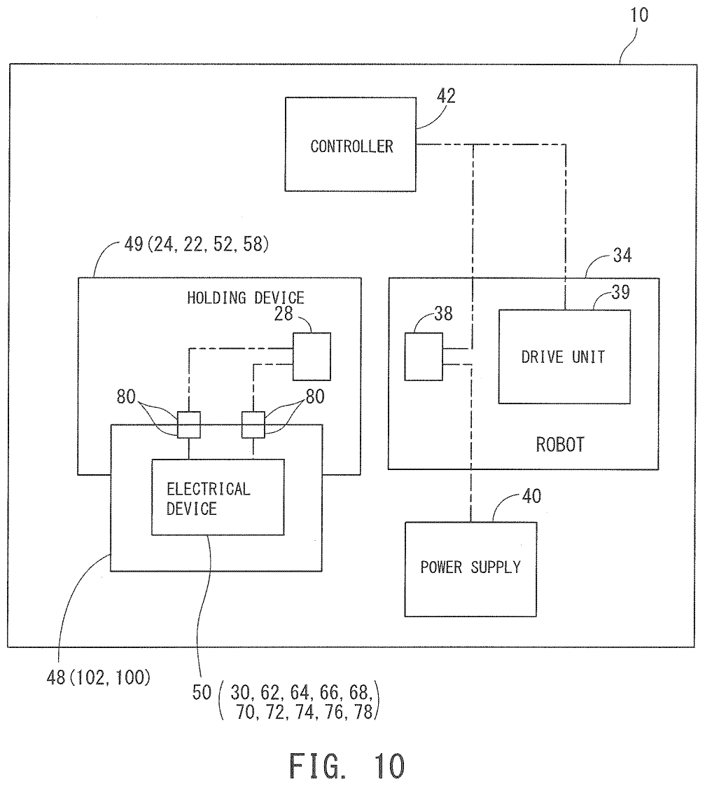

Further, as illustrated in FIG. 9, a plurality of the first connectors 28 and the second connectors 38 may be provided. For example, the movable body 48 may include the first connector 28 for relaying power and the first connector 28 for relaying signals. Likewise, the in-machine robot 34 may include the second connector 38 for relaying power and the second connector 38 for relaying signals. In this case, the electrical device 50 may be an electric actuator incorporating the microcomputer 78 and the sensor 76, the battery 70, the Peltier element 64, and the like. Furthermore, as illustrated in FIG. 9, the power supply 40 and the signal transmission/reception unit 82 may be provided outside the machine tool 10. In other words, one or more input/output connectors 84 may be provided in the machine tool 10, and the power supply 40 and the signal transmission/reception unit 82 may be connected to this input/output connector 84, depending on the application.

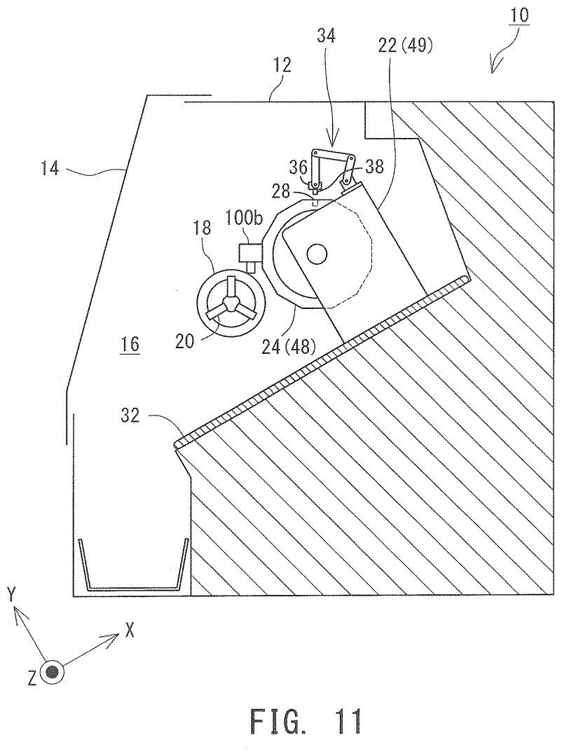

Further, as illustrated in FIG. 10, the first connector 28 may be provided in the holding device 49 holding the movable body 48 in which the electrical device 50 is provided. In this case, the movable body 48 may be a body provided in the machine tool 10 so as to be inseparable therefrom; for example, the tool holder 102, the tool 100, and the like. Further, the holding device 49 is a device holding this movable body 48 and, for example, may be the turret 24, the tool post 22, the spindle head 52, the table 58, and the like. The electrical device 50 may be a device for receiving power and a device for transmitting and receiving signals. Therefore, the electrical device 50 may be the rotary motor 30, the linear motor 66, the solenoid actuator 62, the solenoid valve 68, the battery 70, the electric cylinder 72, the Peltier element 64, the piezoelectric element 74, the sensor 76, the microcomputer 78, and a combination thereof. Further, the first connector 28 and the second connector 38 may be a connector that can relay both power and signals.

By the way, the movable body 48 or the holding device 49 in which the first connector 28 is provided may move during the period when the electrical device 50 is used. The in-machine robot 34 in which the second connector 38 is provided is required to track and follow the movement of this movable body 48 or the holding device 49 to maintain the connection between the first connector 28 and the second connector 38. In order to facilitate the tracking control of such an in-machine robot 34, the in-machine robot 34 may be installed in the movable body 48 or the holding device 49 in which the first connector 28 is provided. Therefore, for example, as illustrated in FIG. 11, when the first connector 28 is provided in the turret 24 (movable body 48), the in-machine robot 34 may be installed in the tool post 22. Such a configuration allows the in-machine robot 34 to move together with the tool post 22, which facilitates the control of the in-machine robot 34.

Note that the combination of the movable body 48 and the electrical device 50 described so far is just an example and may be changed as needed. Note also that the number of movable bodies 48, electrical devices 50, first connectors 28, and second connectors 38 may also be changed as needed. Therefore, two or more movable bodies 48 may be provided in one processing chamber 16, and each movable body 48 may include one or more electrical devices 50 and one or more first connectors 28. Note also that the number of in-machine robots 34 is not limited to one, but a plurality of in-machine robots 34 may be provided, and each in-machine robot 34 may include one or more second connectors 38.

1. A power/signal transmission structure comprising:
a movable body which has an electrical device, and at least a part of which moves in a processing chamber of a machine tool;
a robot provided in the processing chamber;
a first connector which relays at least one of power and signals, and which is provided in the movable body or a holding device holding the movable body and is electrically connected to the electrical device; and
a second connector which relays at least one of power and signals, and which is provided in the robot, and is electrically connectable to and disconnectable from the first connector as the robot is driven, wherein
at least one of power and signals is transmitted from outside to inside or from inside to outside of the electrical device through the first connector and the second connector.

2. The power/signal transmission structure according to claim 1, wherein
the first connector and the second connector relay at least the power, and
the electrical device is a device driven by the power and includes at least one of a rotary motor, a linear motor, a solenoid, a solenoid valve, a secondary battery, an electric cylinder, a Peltier element, and a piezoelectric element.

3. The power/signal transmission structure according to claim 1, wherein
the first connector and the second connector relay at least the signals, and
the electrical device is a device that transmits and/or receives the signals, and includes at least one of a sensor and a microcomputer.

4. The power/signal transmission structure according to claim 1, wherein
the movable body is any one of a tool post, a turret, an opposite head stock, a tailstock, a telescopic cover, a table, a spindle head, a tool holder, a tool, and a steady rest.

5. The power/signal transmission structure according to claim 1, wherein
the movable body is installed in the machine tool so as to be inseparable therefrom, and
the first connector is provided in the movable body.

6. The power/signal transmission structure according to claim 1, wherein
the movable body is separable from the machine tool,
the holding device is installed in the machine tool so as to be inseparable therefrom, and
the first connector is provided in the holding device.

7. The power/signal transmission structure according to claim 6, wherein
an intermediate connector for relaying an electrical connection between the electrical device and the first connector is provided between the movable body and the holding device.

8. The power/signal transmission structure according to claim 1, wherein
the robot can follow movement of the movable body.

9. The power/signal transmission structure according to claim 7, wherein
the robot is installed in the movable body or a holding device holding the movable body.

10. A machine tool comprising:
a holding device provided in a processing chamber for holding a movable body having an electrical device;
a robot provided in the processing chamber;
a first connector which relays at least one of power and signals, and which is provided in the holding device and is electrically connectable to the electrical device when the movable body is held by the holding device; and
a second connector which relays at least one of power and signals, and which is provided in the robot and is electrically connectable to and disconnectable from the first connector as the robot is driven.
